(19) United States
(12) Patent Application Publication
(10) Pub. No.: US 2010/0259501 A1
(43) Pub. Date: Oct. 14, 2010

(54) TOUCH-CONTROL DISPLAY DEVICE

(75) Inventor: Yu-Yuan Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/725,459

(22) Filed: Mar. 17, 2010

Related U.S. Application Data
(60) Provisional application No. 61/168,237, filed on Apr. 10, 2009.

(51) Int. Cl. G06F 3/045; G06F 3/041

(52) U.S. Cl. 345/174; 345/173

(57) ABSTRACT

A touch-control display device includes a frame, a touch-control panel and a display module. The frame has a top surface and a frame rim extending from the top surface, wherein there is a step height between the top surface and the frame rim so as to form a cavity. The touch-control panel is disposed in the cavity and the frame rim supports at least two sides of the touch-control panel. The display module is disposed in the frame and correspondingly assembled under the touch-control panel.

### CROSS-REFERENCE TO RELATED APPLICATION

This application claims the priority benefit of U.S. Provisional application Ser. No. 61/168,237, filed on Apr. 10, 2009. The entirety of the above-mentioned patent application is hereby incorporated by reference herein and made a part of specification.

### BACKGROUND OF THE INVENTION

### 1. Field of the Invention

The present invention generally relates to a display, and more particularly, to a touch-control display device.

### 2. Description of Related Art

The conventional display with a touch-control panel mostly uses a bi-sides tape to fix in adhesion the touch-control panel on a frame enclosing a display module.

FIGS. 1 and 2 are respectively an assembly diagram of a conventional touch-control display device. Referring to FIGS. 1 and 2, the touch-control display device includes a frame 10, a display module 20 fixed in the frame 10 and a touch-control panel 30 fixed on the frame 10. During assembling, the display module 20 is firstly fixed in the frame 10. Then, the touch-control panel 30 covers a top surface 10a of the frame 10 and a bi-sides tape is used to join them for fixing. Although the design herein that the touch-control panel 30 is disposed on the frame 10 can increase the operation area, however since the touch-control panel 30 is higher than the frame 10, not disposed on a same plane, so that there is a distinguished fall between the top surface 30a of the touch-control panel 30 and the top surface 10a of the frame 10 and thereby the side surfaces of the touch-control panel 30 are exposed. In addition, during the assembling operation, if the touch-control panel 30 is positioned by man, a deflection fault often occurs which results in poor reliability.

### SUMMARY OF THE INVENTION

Accordingly, the present invention is directed to a touch-control display device to reduce the fault probability of producing fall between the touch-control panel and the frame.

The present invention provides a touch-control display device, which includes a frame, a touch-control panel and a display module. The frame has a top surface and a frame rim extending from the top surface, wherein there is a step height between the top surface and the frame rim so as to form a cavity. The touch-control panel is disposed in the cavity and the frame rim supports at least two sides of the touch-control panel. The display module is disposed in the frame and correspondingly assembled under the touch-control panel.

In an embodiment of the present invention, the top surface of the above-mentioned touch-control panel and the top surface of the frame are located on a same plane.

In an embodiment of the present invention, the side surface of the above-mentioned touch-control panel is adjacent to the side wall of the cavity.

In an embodiment of the present invention, the dimension of the above-mentioned touch-control panel is larger than the dimension of the display module and the side surface of the touch-control panel is protruded out of the display module.

In an embodiment of the present invention, the display device further includes an adhesive layer adhered between the touch-control panel and the frame rim.

In an embodiment of the present invention, the above-mentioned frame includes an inner frame and an outer frame and the display module is disposed between the inner frame and the outer frame.

In an embodiment of the present invention, the above-mentioned frame further includes a cover plate to cover the inner frame and the cover plate and the outer frame together form a case.

In an embodiment of the present invention, the above-mentioned frame rim is integrally formed on the side wall of the cavity.

In an embodiment of the present invention, the above-mentioned touch-control panel is resistive touch-control panel or capacitive touch-control panel.

In an embodiment of the present invention, the above-mentioned display module is liquid crystal display module (LCD module), plasma display module or organic electroluminescent display (OELD).

Based on the depiction above, the touch-control panel in the present invention is disposed in the cavity of the frame, not on the top surface of the frame, so that the fault of producing fall between the touch-control panel and the frame can be reduced. Besides, the side surfaces of the touch-control panel and the side walls of the cavity are close to each other, the uncertainty of the assembling position in the prior art can be reduced, and the side surfaces are not exposed which avoids an external force to hit to strip the side surfaces and avoids moisture from being seeped into the touch-control panel. In short, the present invention can increase the reliability of the product.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 and 2 are respectively an assembling diagram of a conventional touch-control display device.

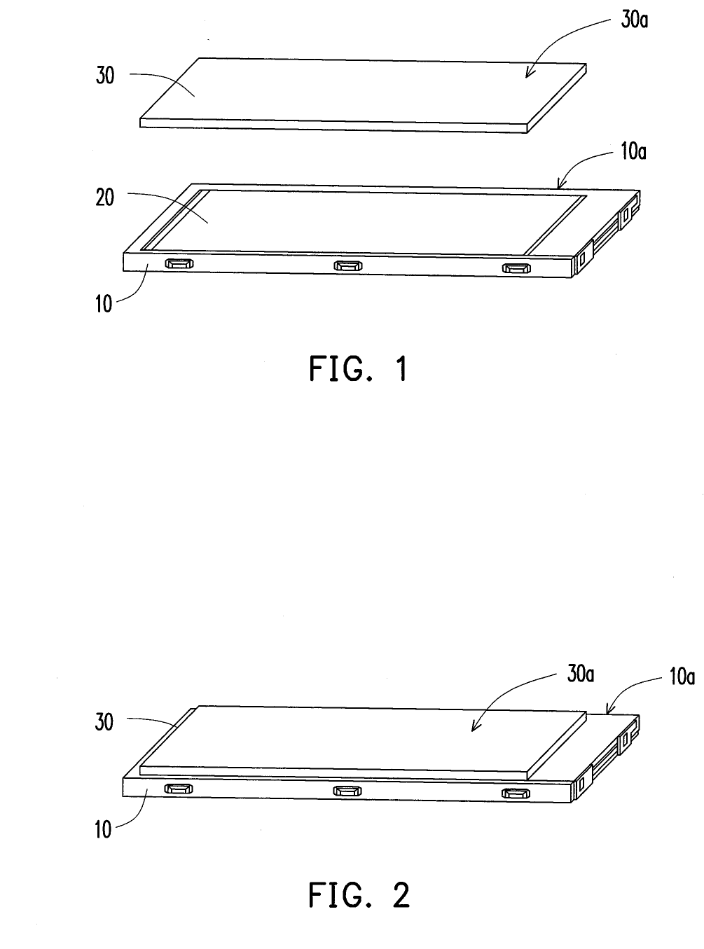

FIGS. 3 and 4 are respectively a local sectional diagram during assembling of a touch-control display device according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

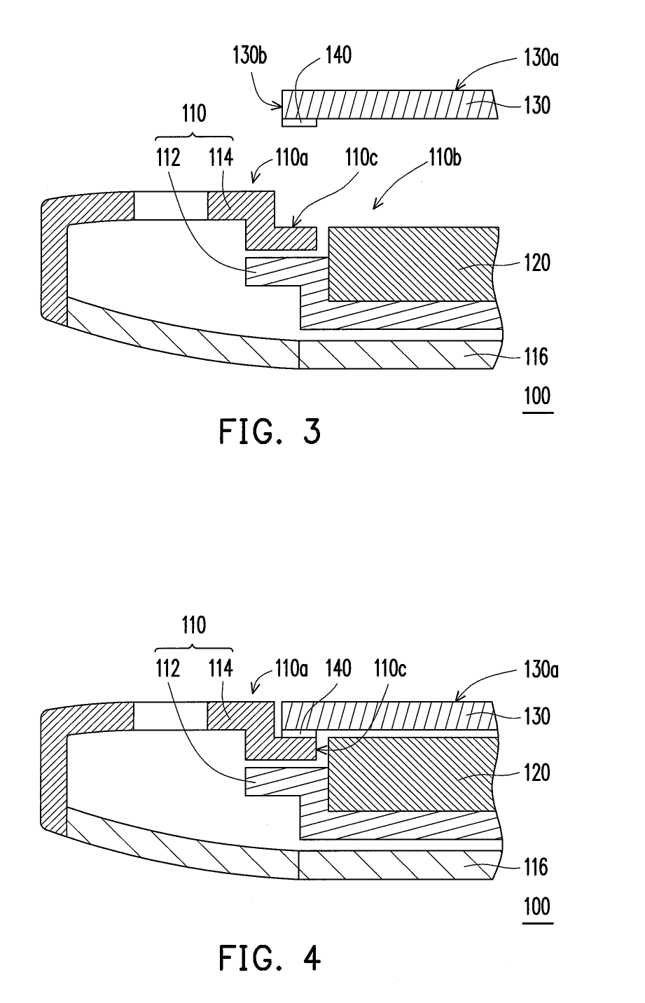

FIGS. 3 and 4 are respectively a local sectional diagram during assembling of a touch-control display device according to an embodiment of the present invention. Referring FIGS. 3 and 4, a touch-control display device 100 includes a frame 110, a display module 120 and a touch-control panel 130. The frame 110 includes a top surface 110a and a frame rim 110c extending from the top surface 110a. There is a step height between the top surface 110a and the frame rim 110c so as to form a cavity 110b, which means the top surface 110a joins downwards the frame rim 110c along the side wall of the cavity 110b so as to form a stepped surface.

The touch-control panel 130 is disposed in the cavity 110b and at least two sides (only one side is shown herein) of the touch-control panel 130 are supported on the frame rim 110c. In addition, the display module 120 is disposed in the frame 110 and correspondingly assembled under the touch-control panel 130. During the assembling, the display module 120 is firstly fixed in the inner frame 112 of the frame 110, followed by laying the outer frame 114 on the inner frame 112 so as to dispose the display module 120 between the inner frame 112 and the outer frame 114. After that, the touch-control panel 130 is disposed in the cavity 110b of the frame 110 so that the top surface 130a of the touch-control panel 130 and the top surface 110a of the frame 110 are roughly located on the same plane and thereby the distinguish fall between the touch-control panel 130 and the frame 110 is avoided.

When the touch-control panel 130 is disposed in the cavity 110b of the frame 110, an adhesive layer 140 can be disposed between the touch-control panel 130 and the frame rim 110c supporting the touch-control panel 130, wherein the adhesive layer 140 can be, for example, a bi-sides tape for fixing the touch-control panel 130. Since the dimension of the cavity 110b is roughly equal to the dimension of the touch-control panel 130, the side surface 130b of the touch-control panel 130 is almost adjacent to the side wall of the cavity 110b without producing an excessive gap. On the other hand, the transverse dimension (length/width) of the touch-control panel 130 can be larger than the transverse dimension (length/width) of the display module 120 and the side surface 130b of the touch-control panel 130 is protruded out of the display module 120 so that the operation area of the touch-control panel 130 is larger than the displaying area of the display module 120.

In the embodiment, the frame rim 110c is integrally formed in stamping or moulding and has L-shape for supporting the touch-control panel 130. Besides, the frame 110 can also have a cover plate 116 to cover the inner frame 112, wherein the cover plate 116 and the outer frame 114 together form a case. The touch-control panel 130 is, for example, resistive touch-control panel or capacitive touch-control panel, which have good optical transmittance to allow the light produced by the display module 120 under the touch-control panel 130 to be incident upon and go through the touch-control panel 130. The patterned electrode (not shown) inside the touch-control panel 130 is made of transparent conductive material such as indium tin oxides (ITO), indium zinc oxide (IZO). Over the touch-control panel 130, a protection layer such as transparent glass, color filter or lens is disposed, wherein the detailed structure and the operation thereof are omitted to describe. In addition, the display module 120 is, for example, liquid crystal display module (LCD module), plasma display module or organic electroluminescent display (OELD), and the detailed structure and the operation thereof are omitted to describe as well.

In summary, the design of the present invention features that the touch-control panel is disposed in the cavity of the frame, not at the top surface of the frame, so that the fault of producing a fall between the touch-control panel and the frame can be avoided. Moreover, the side surfaces of the touch-control panel and the side wall of the cavity are adhered by each other, which can reduce the uncertainty of the assembling position in the prior art, and since the side surfaces are not exposed so as to avoid an external force to hit to strip the side surfaces and avoid moisture from being seeped into the touch-control panel. In short, the present invention can increase the reliability of the product.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A touch-control display device, comprising:
a frame, having a top surface and a frame rim extending from the top surface, wherein there is a step height between the top surface and the frame rim so as to form a cavity;
a touch-control panel, disposed in the cavity, wherein the frame rim supports at least two sides of the touch-control panel; and
a display module, disposed in the frame and correspondingly assembled under the touch-control panel.

2. The touch-control display device as claimed in claim 1, wherein the top surface of the touch-control panel and the top surface of the frame are located on a same plane.

3. The touch-control display device as claimed in claim 1, wherein a side surface of the touch-control panel is adjacent to a side wall of the cavity.

4. The touch-control display device as claimed in claim 1, wherein a dimension of the touch-control panel is larger than a dimension of the display module and a side surface of the touch-control panel is protruded out of the display module.

5. The touch-control display device as claimed in claim 1, further comprising an adhesive layer adhered between the touch-control panel and the frame rim.

6. The touch-control display device as claimed in claim 1, wherein the frame comprises an inner frame and an outer frame and the display module is disposed between the inner frame and the outer frame.

7. The touch-control display device as claimed in claim 6, wherein the frame further comprises a cover plate to cover the inner frame and the cover plate and the outer frame together form a case.

8. The touch-control display device as claimed in claim 1, wherein the frame rim is integrally formed on a side wall of the cavity.

9. The touch-control display device as claimed in claim 1, wherein the touch-control panel is resistive touch-control panel or capacitive touch-control panel.

10. The touch-control display device as claimed in claim 1, wherein the display module is liquid crystal display module, plasma display module or organic electroluminescent display.
